(19) United States
(12) Patent Application Publication
(10) Pub. No.: US 2008/0260632 A1
(43) Pub. Date: Oct. 23, 2008

(54) Production of hydrogen from aluminum and water

(76) Inventor: Jasbir Kaur Anand, Seattle, WA (US)

Correspondence Address: TODD N. HATHAWAY, 119 N. COMMERCIAL ST. #620, BELLINGHAM, WA, 98225, US

(21) Appl. No.: 11/897,575

(22) Filed: Aug. 30, 2007

Related U.S. Application Data
(60) Provisional application No. 60/841,370, filed on Aug. 30, 2006.
(60) Provisional application No. 60/857,263, filed on Nov. 6, 2006.

(51) Int. Cl. C01B 3/08; C09K 3/00

(52) U.S. Cl. 423/657; 252/183.14

(57) ABSTRACT

A method and compositions for producing hydrogen by water split reaction, at near neutral pH conditions and without requiring preheating of the reactant materials. Metallic aluminum in particulate form is blended particulate with a water-soluble inorganic salt that causes progressive pitting of the aluminum to prevent passivation and a particulate metal oxide initiator that raises the temperature of the reactant material upon exposure to water to a level which initiates reaction of water with the metallic aluminum to generate hydrogen. The metal oxide initiator may be an oxide of a Group II metal, such as calcium oxide. The catalyst may be a water soluble inorganic salt having an aggressive anion, such as the halides, sulfites, sulfates and nitrates of Group I and Group II metals, with sodium chloride being preferred. The particles of metallic aluminum are discrete from but blended with those of the salt and oxide. Blending may be performed in a drum or other mixer, and the metal component may be combined with the catalyst and initiator previously or in a reactor just prior to reaction. The reaction initiates upon adding water, and is capable of generating hydrogen at both low and elevated pressures. The reaction products can be recycled or disposed of safely through ordinary channels.

### RELATED APPLICATIONS

This application claims the benefit of U.S. Provisional Patent Application No. 60/841,370 filed on Aug. 30, 2006 and U.S. Provisional Patent Application No. 60/857,263 filed on Nov. 6, 2006.

### BACKGROUND

a. Field of the Invention

The present invention relates generally to the production of hydrogen, and, more particularly to methods and compositions for producing hydrogen by reacting an aluminum-containing particulate material with water.

b. Related Art

Hydrogen-based fuel systems hold the promise of clean power from a renewable resource, i.e., water. In some instances, combustion of hydrogen in manner similar to that of fossil fuels (e.g., in a combustion engine) has been used or proposed, however, the efficiencies are comparatively low and a certain amount of environmentally undesirable emissions is inevitable; moreover, combustion-based systems are not suitable for use in many products, such as portable electrical and electronic devices.

Hydrogen, the most abundant element in the universe, is rarely found in its natural form. It is found in many compounds such as: hydrocarbons, carbohydrates, fuels, and water. To separate hydrogen from these compounds as hydrogen fuels is not only complicated and tedious, but it is very expensive too. The most common methods of producing hydrogen are: electrolysis, hydride reactions with water and extraction from fossil fuels such as natural gas or methanol. Hydrogen produced from these methods is compressed and stored in tanks or other containers and transported or distributed to end users. However, such transportation is cost ineffective and dangerous. Therefore, it is preferable to generate hydrogen on demand at, or near, the site of use.

To overcome the barriers of transporting compressed hydrogen cylinders, currently hydrogen is extracted from a liquid hydrocarbon fuel, such as gasoline or methanol. However, this approach also involves the inherent safety hazards of hydrocarbon-fuel transport, along with emission of undesirable pollutants to environment.

Alternatively, hydrogen may be generated on a localized or portable basis by a chemical reaction. As is well known, hydrogen is produced by chemical reaction between water and chemical hydrides, comprising hydrogen and one or more alkyl or alkyl earth metals; examples of metal hydrides that have been utilized in such processes include: lithium hydride (LiH), lithium aluminum hydride (LiAlH₄), lithium borohydride (LiBH₄), sodium hydride (NaH), sodium aluminum hydride (NaAlH₄) and sodium borohydride (NaBH₄). As a group, however, these reactions are violent, to the point of being explosive in a runaway situation, and are therefore very difficult to control.

Another method of generating hydrogen is by water split chemical extraction, where a metal species is reacted with water. These reactions offer many advantages over those described above, notably in terms of the benign qualities of both the reaction and its products. However, such water-split reactions are difficult to initiate and sustain, in part due to a tendency for reaction products to build up and cause passivation at the surface of the metal. One solution to passivation is provided by U.S. Pat. No. 6,582,676 (Chaklader), in which metallic aluminum is mechanically alloyed with alumina and/or certain other materials and pressed into pellet form. However, among other difficulties, the step of mechanically alloying the materials (e.g., using a pulverizer) is energy intensive and adds a very significant cost that impairs the economic viability of the process.

Accordingly, there exists a need for a method and composition for generation of hydrogen from water as a renewable resource, which are efficient in terms of both energy utilized and reactants consumed. Moreover, there exists a need for such a method and composition in which the reaction takes place in a readily controlled manner and at or near ambient temperatures and pH levels for the sake of efficiency and safety. Still further, there exists a need for such a method and composition that does not require compressed hydrogen or other potentially dangerous materials to be transported to the end user. Still further, there exists a need for such a method and composition that are environmentally benign and do not produce undesirable waste or byproducts. Still further, there exists a need for such a method and composition that avoids the need for mechanical alloying or other expensive processing of the materials used in the reaction.

### SUMMARY OF THE INVENTION

The present invention overcomes the problems described above, and generates hydrogen using a blended powder containing a non-alloyed particulate aluminum and a catalyst and initiator that support reaction of the aluminum with water.

Preparation of the powdered material is achieved by convenient and economical methods, suitable to be performed on an industrial scale. Reaction of the material with water provides a safe, low cost, environmentally friendly method for on-demand supply of substantially pure hydrogen (H₂) for fuel cells, other similar user devices, and for internal combustion engines. The system can be scaled as desired, for example, for use in portable devices, such as electronics and transportable equipment, or for emergency and household power supplies.

The reaction initiates without requiring preheating of the materials. Reaction temperatures are far lower than with chemical hydrides, alleviating the possibility of a runaway reaction and therefore permitting the design of a self-controlling H₂ generation system.

The particulate material is in the form of a blended powder combining particulate metallic aluminum, one or more water soluble inorganic salts, and metal oxides. The particulate aluminum is discrete from the salt(s) and metal oxide(s) and is not mechanically alloyed therewith. Other metals such as magnesium and zinc may be used, but aluminum is preferred. The water soluble salts act as a catalyst that prevents passivation, and can be recovered or flushed down the drain after the reaction, while the metal oxides act as a reaction initiator.

The preferred mix contains metallic aluminum particulate mixed with at least one alkali salt and at least one alkaline earth metal oxide. The material effectively hydrolyzes water to hydrogen at neutral or near neutral pH ranges, without experiencing passivation. The material creates essentially no emissions and the “waste product” of the reaction (primarily Al(OH)₃) is not only environmentally benign (being essentially the same as naturally-occurring bauxite), but can also be readily recycled in the production of aluminum if desired.

The reaction has an added advantage of being able to proceed at comparatively high pressures. Moreover, once water has been added to the aluminum composite material the reaction will proceed to completion, i.e., until one of the reactants, i.e. either the water or metal-containing mix has been consumed.

Therefore, in a broad aspect, the method of the present invention comprises the steps of: (a) providing a particulate reactant material comprising particles of metallic aluminum for reacting with water to generate hydrogen, a catalyst effective to create progressive pitting of the metallic aluminum when reacting with water, and an initiator effective to raise the temperature of the reactant material upon exposure to water, the particles of metallic aluminum being substantially discrete from but blended with the catalyst and initiator, and (b) selectively combining the reactant material with water, so that the initiator raises the temperature to a level which initiates reaction of water with the aluminum to generate hydrogen, and the catalyst prevents passivation of the aluminum so as to enable the reaction to continue on a sustained basis.

The catalyst may comprise a water soluble inorganic salt. The water soluble inorganic salt may be selected from the group consisting of halides, sulfites, sulfates and nitrates of Group 1 and Group 2 metals and combinations thereof. The salt may be selected from a group consisting of sodium chloride, potassium chloride, potassium nitrate and combinations thereof. In the preferred embodiment, the inorganic salt is sodium chloride, in varied ratios of about 1:3 to about 0.1:10 of the metallic aluminum by weight.

The initiator may comprise a metal oxide. The metal oxide may be selected from the group consisting of oxides of Group 2 metals. The metal oxide may be selected from the group consisting of calcium oxide, magnesium oxide, barium oxide and combinations thereof. In the preferred embodiment, the metal oxide is calcium oxide, in an amount from about 1% to about 12% of said reactant material by weight.

The metallic aluminum, catalyst and initiator may be mixed in particulate form to form the reactant material. The metallic aluminum, catalyst and initiator may be manually blended. The step of combining the reactant material with water may comprise combining the reactant material with water at ambient temperature and at neutral pH. The method may further comprise the step of generating the hydrogen under an elevated pressure in the range from about 20 psig to about 1000 psig, or much higher pressures.

The invention further provides a particulate material for being selectively reacted with water to produce hydrogen.

Broadly, the particulate material comprises particles of metallic aluminum, an initiator effective to raise the temperature of the material upon exposure to water, to a level which initiates reaction of water with said aluminum to generate hydrogen, and a catalyst effective to create progressive pitting of the metallic aluminum when reacting with water, so as to prevent passivation of the aluminum and thereby enabling the reaction to continue on a sustained basis, the particles of metallic aluminum being substantially discrete from but blended with the initiator and catalyst.

The initiator may comprise a metal oxide, and may be a metal oxide selected from the group consisting of metal oxides of Group 2 metals and combinations thereof. The metal oxide may be selected from the group consisting of calcium oxide, magnesium oxide, barium oxide and combinations thereof. In a preferred embodiment, the metal oxide is calcium oxide, in an amount from about 1% to about 12% of the reactant material by weight.

The catalyst may comprise a water soluble inorganic salt, and may be selected from the group consisting of halides, sulfites, sulfates and nitrates of Group 1 and Group 2 metals, and combinations thereof. The inorganic salt may be selected from the group consisting of sodium chloride, potassium chloride, potassium nitrate and combinations thereof. In a preferred embodiment, the inorganic salt is sodium chloride, in a ratio of about 1:3 to about 1:100 to the metallic aluminum by weight.

The size of the particles of metallic aluminum may be in the range from about 80 mm to about 2500 mm; the size preferably is about 300 mm.

The metallic aluminum, catalyst and initiator may be mixed in powdered form to form the blended reactant material. The mixing may be performed by stirring, tumbling or even hand mixing.

These and other features and advantages of the present invention will be more fully appreciated from a reading of the following detailed description with reference to the accompanying drawings.

### BRIEF DESCRIPTION OF THE DRAWINGS

FIG. 1 is a bar graph of test data showing yield percents of hydrogen relative to the percentage of aluminum in the reactant material of the present invention; and

FIG. 2 is a bar graph of data showing yield percentages of hydrogen relative to percentage of aluminum in the reactant material, comparing the performance of a mechanically alloyed material with that of the blended powder material of the present invention.

### DETAILED DESCRIPTION

a. Overview

The present invention provides a method and composition that produces hydrogen using an aluminum-based water-split reaction, in which passivation is prevented but without requiring mechanical alloying of the aluminum with another material; only a blending of powdered materials is needed. The cost is therefore greatly reduced by comparison with prior approaches, and the overall weight energy density of the material is also increased.

The composition is a particulate mixture of metallic aluminum, a water soluble salt catalyst, and a metal oxide initiator. Magnesium and zinc may also be used in the reaction and may be present with the aluminum, but are unattractive in terms of cost, performance and environmental impact. The metallic aluminum is in the form of distinct particles discrete from those of the catalyst and the imitator, without requiring mechanical alloying of the materials. The material is reacted with water to generate hydrogen at ambient temperatures and pressures, and at neutral or near neutral pH levels. The reactants therefore achieve an accelerated and efficient water split reaction using (for example) ordinary tap water, and without preheating. Furthermore, complex regulation of the reactants is not needed. However, the reaction is also highly productive when conducted at elevated temperatures and pressures.

The catalyst is suitably an alkali salt, such as sodium chloride (NaCl) or potassium chloride (KCl). The initiator is suitably an alkaline earth metal oxide, such as calcium oxide (CaO).

The starting pH is suitably in the range of about 4-11, preferably in the range of about 5-10, at ambient temperatures and at atmospheric or elevated pressures (e.g., from 14 psig to 1000+ psig).

The metallic aluminum, catalyst, and initiator are each preferably in powdered form, and are mixed to achieve a substantially uniform distribution. The size of the aluminum particles is suitably in the range from about 80 micrometers to about 2500 micrometers, with a size of about 300 micrometers being eminently suitable for many or most purposes, although it will be understood that other sizes may be used in some cases. The particles need not be of a uniform size, and different sizes may be mixed to adjust reaction characteristics or for other purposes, e.g., a combination of 100 micrometers and 1200 micrometers particles might be used. The size of the particles of catalyst and initiator materials is suitably within the same ranges as for the aluminum particles although any size the mixes effectively with the particulate aluminum and dissolves/reacts with water in a sufficiently rapid manner may be used.

The mixing is suitably performed by stirring or tumbling. The mixture is stable, in the absence of water, and is easily transported without being hazardous. The mixture can be combined with water simply as an unconsolidated powder; the mixture is reactive at ambient temperatures and at elevated temperatures as well. The mixture may also be formed into pellets.

The reaction can initiate at ambient temperatures. The starting pH is suitably in the range of about 4-8, preferably in the range of about 5-7.5, at ambient temperatures and at atmospheric and elevated pressures (e.g., 14 psig to 1000+ psig) and remains substantially neutral (i.e., in the range of about 4-10) for the duration of the reaction. The reaction yields substantially the same amount of hydrogen whether at ambient or elevated temperatures.

The principle products of the reaction are hydrogen (H₂), aluminum hydroxide (Al(OH)₃), calcium hydroxide (Ca(OH)₂), and calcium oxide (CaO) and steam, all of which are substantially benign in character. Aluminum can be regenerated from aluminum hydroxide, hence the reaction products are recyclable.

The present invention thus renders it practically and economically feasible to generate hydrogen by reacting aluminum with water, under far more controllable and safe conditions than with the chemical hydride reactions described above. The economic viability of the process is greatly enhanced by the simple and economical manner in which the material can be made and blended, as opposed to the costly, energy intensive pulverizing and milling required for mechanical alloying. As an additional advantage, the aluminum smelters that produce the metallic component typically employ hydroelectric power, so that in terms of energy consumption, production of the primary material used in the reaction employs a renewable energy resource that creates essentially no emissions.

b. Reaction Process and Material

As is well known, aluminum metal reacts with water to generate hydrogen, but also forms Al(OH)₃ or AlOOH, and Al₂O₃. These three chemicals tend to deposit on metal surface and restrict the further reaction of water with metal; this, referred to as “passivation”, is an important property of Al metal and preserves the metal from further corrosion under neutral conditions. Passivation of aluminum or other metals consequently plays a significant role inhibiting the hydrogen generation from water and aluminum at near-neutral pH levels.

The present invention prevents passivation by exposing the aluminum to water soluble inorganic salts, particularly halide salts, which act as catalysts to create a sequential pitting process. Pitting corrosion is initiated by aggressive anions like chlorides, nitrates, and sulfates of alkali or alkaline earth metals. The pits are formed by halide/chloride ion adsorption at the metal oxide surface, followed by penetration of oxide film, corrosion pit propagation and rupture of corrosion cells due to enclosed hydrogen formation.

The catalysts are therefore selected from water soluble inorganic salts, primarily the halides, sulfides, sulfates and nitrates of Group 1 or Group 2 metals and their mixtures. As a result, the catalyst salt has a very high solubility in water. The preferred water-soluble catalysts include NaCl, KCl, and NaNO₃, in pure or combined form; NaCl is generally most preferred, owing to its efficacy and low cost as well as benign characteristics, whereas KCl is a suspected mutagenic compound and therefore less desirable from a safety standpoint.

The initiator is suitably an alkaline earth metal oxide; other metal oxides may be used, but many yield reaction products that interfere with the aluminum-water split reaction or are undesirable from a safety or environmental standpoint, or both. CaO, MgO and BaO are preferred, with CaO being most preferred due to its efficacy and the benign nature of both the material itself and its reaction products. The initiator reacts to raise the temperature of the material when exposed to water. The increase is modest and therefore safe as compared with other, exothermic reactions, but is sufficient to raise the temperature to a level at which the water-aluminum reaction initiates, thus obviating the need for preheating.

The particles of metal, water soluble inorganic salt and metal oxide initiator are thoroughly blended or mixed, preferably in a finely-powdered form, in order for the water soluble salt to be most effective as a catalyst to support the water split reaction, mixing may be by stirring or tumbling (e.g., in a drum), or even by hand/manually. Thus the current invention eliminates any need for the expensive steps of pulverizing and milling to alloy the aluminum and catalyst mix. The blending may be performed at some prior time, such as at a plant or faculty, or it may be done at or in the reactor vessel itself.

The reaction will ordinarily be performed in a reactor or other vessel that captures the hydrogen for use and that may be provided with suitable controls for introducing the water and/or particulate.

The reaction can be customized to generate the desired amount of hydrogen at a linear controlled rate at a set pressure or pressures. The reactions can be modified to generate hydrogen at low pressures around 10 psig to pressure as 8000 psig (or potentially more), depending upon the needs of particular application and can be used in stationary or portable generators.

The proportion of metal oxide initiator may vary from 1% to about 12% concentrations and reaction can yield 60%-95% or more, again with a significant energy saving since there is no need for mechanical alloying.

The reaction products from the water split reaction can be recycled if desired, or the effluent can simply be flushed down a drain and spent fuel disposed of without any contamination concerns.

### Test Results

The results of tests using mix compositions in accordance with the present invention are set forth in the following Table 1.

TABLE 1

| | Aluminum a | Catalyst b | Initiator c | Total d | | | |
|---|---|---|---|---|---|---|---|
| S. No. | (g) | (g) | (g) | (g) | H₂ total L e | H₂/g L f | % Yield g |
| 1 | 54 | 20 | 15 | 89 | 60 | 1.11 | 81.70 |
| 2 | 54 | 20 | 15 | 89 | 57 | 1.06 | 77.61 |
| 3 | 54 | 19 | 12 | 85 | 66 | 1.22 | 89.87 |
| 4 | 54 | 19 | 12 | 85 | 58 | 1.07 | 78.98 |
| 5 | 54 | 14 | 10 | 78 | 48 | 0.89 | 65.36 |
| 6 | 54 | 14 | 10 | 78 | 51 | 0.94 | 69.44 |
| 7 | 54 | 9 | 10 | 73 | 45 | 0.83 | 61.27 |
| 8 | 54 | 9 | 10 | 73 | 45 | 0.83 | 61.27 |
| 9 | 104 | 14 | 15 | 133 | 63 | 0.61 | 44.54 |
| 10 | 104 | 14 | 15 | 133 | 82 | 0.79 | 57.98 |
| 11 | 483.3 | 66.7 | 50 | 600 | 388 | 0.80 | 59.03 |
| 12 | 483.3 | 66.7 | 50 | 600 | 553 | 1.14 | 84.13 |
| 13 | 483.3 | 66.7 | 50 | 600 | 475 | 0.98 | 72.27 |
| 14 | 488.3 | 61.7 | 50 | 600 | 417 | 0.85 | 62.79 |
| 15 | 523 | 32 | 25 | 580 | 599 | 1.15 | 84.21 |
| 16 | 523 | 32 | 25 | 580 | 600 | 1.15 | 84.35 |
| 17 | 748 | 66 | 50 | 864 | 770 | 1.03 | 75.69 |
| 18 | 624 | 61 | 40 | 725 | 632 | 1.01 | 74.47 |
| 19 | 808 | 66 | 42 | 916 | 893 | 1.11 | 81.26 |
| 20 | 980 | 120 | 80 | 1180 | 900 | 0.92 | 67.53 |
| 21 | 808 | 66 | 42 | 916 | 893 | 1.11 | 81.26 |
| 22 | 980 | 120 | 80 | 1180 | 900 | 0.92 | 67.53 |
| 23 | 25.4 | 8 | 7 | 39.4 | 22.58 | 0.89 | 64.89 |
| 24 | 980 | 120 | 80 | 1180 | 1247 | 1.27 | 93.66 |
| 25 | 980 | 120 | 80 | 1180 | 1280 | 1.31 | 96.12 |
| 26 | 25.4 | 8 | 7 | 39.4 | 24.4 | 0.96 | 70.71 |

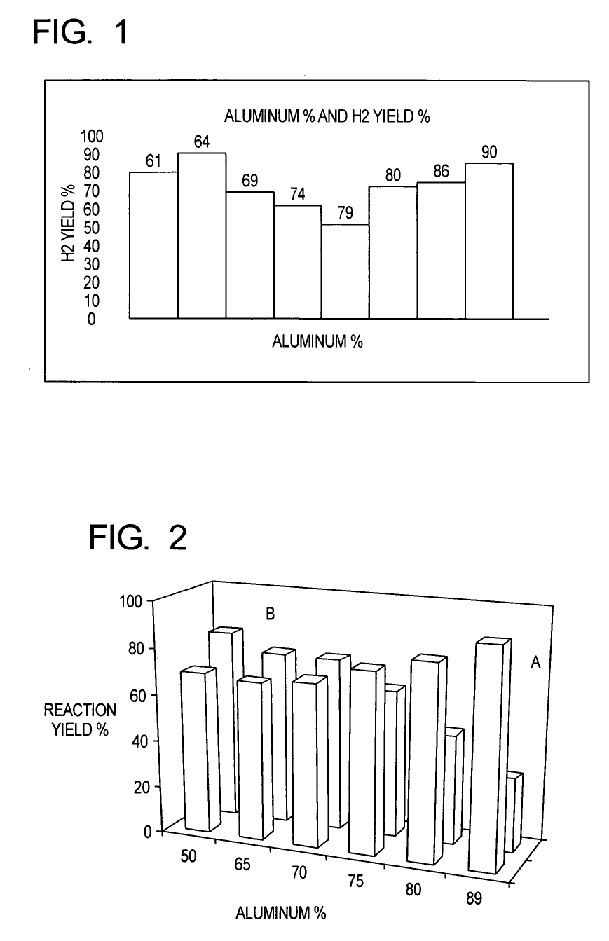

As can be seen, the reactions all produced yields of hydrogen in excess of 50%, in some cases reaching 95+%. Average data results of hydrogen yield verses percentage aluminum in the mix, for these and additional tests, are set forth in FIG. 1.

Table 2 signifies the total amount of hydrogen produced from 100 g of powder mix. Reactions 1-4 show the data obtained using milled, mechanically alloyed material and reactions 5-8 show the data obtained using the blended powder mix of the present invention. As can be seen, the results obtained with the non-alloyed mix of the present invention compare favorably with those of the alloyed mix, without the cost and energy expenditure required for the mechanical alloying process, with the mix of the present invention demonstrating an ability to produce a greater total amount of hydrogen per a given weight of material.

TABLE 2

| | Aluminum a | Catalyst b | Initiator c | Total d | % Yield | H₂/g L | |
|---|---|---|---|---|---|---|---|
| S. No. | (g) | (g) | (g) | (g) | g | f | H₂ total L e |
| 1 | 48 | 48 | 4 | 100 | 87 | 1.18 | 56.75 |
| 2 | 48 | 48 | 4 | 100 | 88 | 1.20 | 57.41 |
| 3 | 48 | 48 | 4 | 100 | 89 | 1.21 | 58.06 |
| 4 | 48 | 48 | 4 | 100 | 94 | 1.28 | 61.32 |
| 5 | 78 | 10 | 12 | 100 | 70 | 0.95 | 74.2 |
| 6 | 83 | 7 | 10 | 100 | 81 | 1.10 | 91.36 |
| 7 | 82 | 11 | 7 | 100 | 96 | 1.30 | 107 |
| 8 | 89 | 5.5 | 5.5 | 100 | 95 | 1.31 | 117 |

FIG. 2, in turn, displays the results test conduced on the basis of percentage yield (H₂) as a function of percentage of aluminum in the mix, for both the blended powdered of the present invention (fount row-A) and the mechanically alloyed material (rear row-B). The results clearly demonstrate the ability of the blended mix to produce higher percentage yields at high percentage of aluminum in the material, confirming the efficiency and greater energy density afforded by the present invention.

It is to be recognized that various alterations, modifications, and/or additions may be introduced into the constructions and arrangements of parts described above without departing from the spirit or ambit of the present invention as defined by the appended claims.

1. A method for producing hydrogen, said method comprising the steps of:
providing a reactant material in the form of a blended particulate material, comprising:
particulate metallic aluminum for reacting with water to generate hydrogen;
a particulate catalyst effective to cause progressive pitting of said metallic aluminum when reacting with water; and
a particulate initiator effective to raise the temperature of said reactant material upon exposure to water;
said metallic aluminum being in the from of particles substantially discrete from but blended with said catalyst initiator; and
selectively combining said reactant material with water, so that said initiator raises the temperature to a level which initiates reaction of water with said metallic aluminum to generate hydrogen and said catalyst prevents passivation of said aluminum so as to enable said reaction to continue on a sustained basis.

2. The method of claim 1, wherein said catalyst comprises:
a water soluble inorganic salt.

3. The method of claim 2, wherein said water-soluble inorganic salt is selected from the group consisting of:
halides, sulfides, sulfates and nitrates of Group 1 and Group 2 metals, and combinations thereof.

4. The method of claim 3, wherein said inorganic salt is selected from the group consisting of:
sodium chloride;
potassium chloride;
potassium nitrate; and
combinations thereof.

5. The method of claim 4, wherein said inorganic salt is sodium chloride, in a ratio of about 1:3 to about 1:100 to said metallic aluminum by weight.

6. The method of claim 2, wherein said initiator comprises:
a metal oxide.

7. The method of claim 6, wherein said metal oxide is selected from the group consisting of:
oxides of Group 2 metals, and combinations thereof.

8. The method of claim 7, wherein said metal oxide is selected from the group consisting of:
calcium oxide;
magnesium oxide;
barium oxide; and
combinations thereof.

9. The method of claim 8, wherein said metal oxide is calcium oxide, in an amount from about 0.1% to 12% of said reactant material by weight.

10. The method of claim 6, wherein said particles of metallic aluminum have a size within the range from about 80 micrometers to about 2,500 micrometers.

11. The method of claim 10, wherein said particles of metallic aluminum have a size of about 300 micrometers.

12. A blended reactant material for being selectively reacted with water to produce hydrogen, said material comprising:
particulate metallic aluminum for reacting with water to generate hydrogen;
a particulate catalyst effective to create progressive pitting of said metallic aluminum when reacting with water, so as to prevent passivation of said aluminum and thereby enable said reaction to continue on a sustained basis; and
a particulate initiator effective to raise the temperature of said material upon exposure to water, to a level which initiates reaction of water with said aluminum to generate hydrogen;
said metallic aluminum being in the form of particles substantially discrete from but blended with said catalyst and initiator.

13. The reactant material of claim 11, wherein said initiator comprises:
a metal oxide.

14. The reactant material of claim 13, wherein said metal oxide is selected from the group consisting of:
oxides of Group 2 metals, and combinations thereof.

15. The reactant material of claim 14, wherein said metal oxide is selected from the group consisting of:
calcium oxide;
magnesium oxide;
barium oxide; and
combinations thereof.

16. The reactant material of claim 15, wherein said metal oxide is calcium oxide, in an amount from about 0.1% to 12% of said reactant material by weight.

17. The reactant material of claim 12, wherein said catalyst comprises:
a water soluble inorganic salt.

18. The reactant material of claim 17, wherein said water-soluble inorganic salt is selected from the group consisting of:
halides, sulfides, sulfates and nitrates of Group 1 and Group 2 metals, and combinations thereof.

19. The reactant material of claim 18, wherein said inorganic salt is selected from the group consisting of:
sodium chloride;
potassium chloride;
potassium nitrate; and
combinations thereof.

20. The reactant material of claim 19, wherein said inorganic salt is sodium chloride, in a ratio of about 1:3 to about 1:100 to said metallic aluminum by weight.

21. The material of claim 15, wherein said particles of metallic aluminum, have a size in the range from about 80 micrometers to about 2,500 micrometers

22. The reactant material of claim 21, wherein said particles of metallic aluminum have a size of about 300 micrometers.

23. A blended particulate material for being selectively reacted with water to produce hydrogen, said material comprising:
particulate metallic aluminum;
particulate sodium chloride in a ratio of about 1:3 to about 1:100 to said aluminum by weight; and
particulate calcium oxide in an amount equal to about 0.1% to 12% of said reactant material by weight;
said metallic aluminum being in the form of particles substantially discrete from but blended with those of said sodium chloride and said calcium oxide.

24. The reactant material of claim 23, wherein said particles of metallic aluminum have a size within the range from about 80 micrometers to about 2,500 micrometers.

25. The reactant material of claim 24, wherein said particles of metallic aluminum have a size of about 300 micrometers.
